(19) United States
(12) Patent Application Publication
(10) Pub. No.: US 2025/0126037 A1
(43) Pub. Date: Apr. 17, 2025

(54) MONITORING DEVICE, VEHICLE MONITORING SYSTEM, AND VEHICLE MONITORING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Shinichi AIBA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/834,718

(22) PCT Filed: Jan. 17, 2023
(86) PCT No.: PCT/JP2023/001148

§ 371 Date: Jul. 31, 2024

(30) Foreign Application Priority Data
Feb. 2, 2022 (JP) 2022-014769

(51) Int. Cl. H04L 43/0823; H04W 4/44

(52) U.S. Cl. CPC H04L 43/0823; H04W 4/44

(57) ABSTRACT

A monitoring device configured to be installed in a vehicle includes: a monitoring unit configured to monitor vehicle-related information regarding the vehicle transmitted in an in-vehicle network in the vehicle; a pattern information generating unit configured to generate pattern information that indicates changes in a plurality of types of the vehicle-related information, based on a result of monitoring performed by the monitoring unit; an abnormality detection unit configured to compare the pattern information generated by the pattern information generating unit with reference information that is pattern information used for reference, and detects an abnormality in the in-vehicle network based on a result of comparison; and a transmission unit configured to transmit the pattern information and the reference information to an external device outside the vehicle when the abnormality is detected by the abnormality detection unit.

### CROSS-REFERENCE TO RELATED APPLICATIONS

This application is the U.S. national stage of PCT/JP2023/001148 filed on Jan. 17, 2023 which claims priority of Japanese Patent Application No. JP 2022-014769 filed on Feb. 2, 2022, the contents of which are incorporated herein.

### TECHNICAL FIELD

The present disclosure relates to a monitoring device, a vehicle monitoring system, and a vehicle monitoring method.

### BACKGROUND

JP 2021-167985A discloses the following technology. An in-vehicle security system includes a first electronic control device and a second electronic control device capable of communicating with the first electronic control device, the second electronic control device executes first processing in response to an input from the first electronic control device and gives a reply to the first electronic control device indicating that second processing different from the first processing has been executed in response to the input.

JP 2019-128934A discloses the following technology. An abnormality determination apparatus included in a first node that is a target to be monitored on a V2X network includes a processor configured to perform operations including: a log information obtaining step of obtaining log information including a time and status information indicating a status of the first node at the time indicated by at least one of sensor data or control data on the first node; a first abnormality determination step of making a first abnormality determination regarding an occurrence of an abnormality on the first node at the time; a second abnormality determination step of making a second abnormality determination regarding an occurrence of an abnormality on a second node at the time based on second node information regarding an abnormality in the second node obtained from the second node, the second node being another node that is a target to be monitored on the V2X network and is in a surrounding area of the first node; an abnormality information adding step of adding, when a result of the second abnormality determination indicates an occurrence of an abnormality on the second node, to the log information, abnormality information indicating the occurrence of the abnormality on the second node; and a log information transmitting step of transmitting the log information added with the abnormality information to at least one node that constitutes the V2X network.

JP 2018-152745A discloses the following technology. A recording device includes: a storage unit storing therein a plurality of patterns of an order in which a plurality of types of packets provided with IDs are transmitted in an in-vehicle network in a predetermined cycle; a receiving unit that receives the plurality of types of packets from the in-vehicle network; a first recording unit that records, as inspection data, a pattern, in each cycle, that matches with a reception order of the plurality of types of packets received by the receiving unit, out of the plurality of patterns stored in the storage unit; and a second recording unit that records, as the inspection data, data of the plurality of types of packets received by the receiving unit.

There is demand for a technology that makes it possible to grasp the state of a vehicle more accurately than the technologies described in JP 2021-167985A, JP 2019-128934A and JP 2018-152745A and make appropriate determination on abnormalities in the vehicle.

The present disclosure was made to solve the above problem, and it is an object of the present disclosure to provide a monitoring device, a vehicle monitoring system, and a vehicle monitoring method that make it possible to grasp the state of a vehicle more accurately and make appropriate determination on abnormalities in the vehicle.

### SUMMARY

Technologies for improving security in an in-vehicle network have been conventionally developed.

A monitoring device according to the present disclosure is configured to be installed in a vehicle and includes: a monitoring unit configured to monitor vehicle-related information regarding the vehicle transmitted in an in-vehicle network in the vehicle; a pattern information generating unit configured to generate pattern information that indicates changes in a plurality of types of the vehicle-related information, based on a result of monitoring performed by the monitoring unit; an abnormality detection unit configured to compare the pattern information generated by the pattern information generating unit with reference information that is pattern information used for reference, and detect an abnormality in the in-vehicle network based on a result of comparison; and a transmission unit configured to transmit the pattern information and the reference information to an external device outside the vehicle when the abnormality is detected by the abnormality detection unit.

A vehicle monitoring system according to the present disclosure includes: a monitoring device configured to be installed in a vehicle; and an external device outside the vehicle, wherein the monitoring device includes: a monitoring unit configured to monitor vehicle-related information regarding the vehicle transmitted in an in-vehicle network in the vehicle; a pattern information generating unit configured to generate pattern information that indicates changes in a plurality of types of the vehicle-related information, based on a result of monitoring performed by the monitoring unit; an abnormality detection unit configured to compare the pattern information generated by the pattern information generating unit with reference information that is pattern information used for reference, and detect an abnormality in the in-vehicle network based on a result of comparison; and a transmission unit configured to transmit the pattern information and the reference information to the external device outside the vehicle when the abnormality is detected by the abnormality detection unit, and the external device analyzes the pattern information and the reference information received from the monitoring device.

A vehicle monitoring method according to the present disclosure is performed by a monitoring device installed in a vehicle and includes: monitoring vehicle-related information regarding the vehicle transmitted in an in-vehicle network in the vehicle; generating pattern information that indicates changes in a plurality of types of the vehicle-related information, based on a result of monitoring; comparing the generated pattern information with reference information that is pattern information used for reference, and detecting an abnormality in the in-vehicle network based on a result of comparison; and transmitting the pattern information and the reference information to an external device outside the vehicle when the abnormality is detected.

An aspect of the present disclosure can be realized not only as the monitoring device including these characteristic processing units but also as a program for causing a computer to execute such characteristic processing. Also, an aspect of the present disclosure can be realized as a semiconductor integrated circuit that realizes some or all of the units of the monitoring device.

### ADVANTAGEOUS EFFECTS

According to the present disclosure, it is possible to grasp the state of a vehicle more accurately and make appropriate determination on abnormalities in the vehicle.

### BRIEF DESCRIPTION OF DRAWINGS

FIG. 1 is a diagram showing a configuration of a vehicle monitoring system according to an embodiment of the present disclosure.

FIG. 2 is a diagram showing a configuration of an in-vehicle communication system according to an embodiment of the present disclosure.

FIG. 3 is a diagram showing a configuration of a gateway device included in the in-vehicle communication system according to an embodiment of the present disclosure.

FIG. 4 is a diagram showing an example of travel states of a vehicle determined by the gateway device according to an embodiment of the present disclosure.

FIG. 5 is a diagram showing an example of time series data of signal values obtained in the in-vehicle communication system according to an embodiment of the present disclosure.

FIG. 6 is a diagram showing an example of pattern information generated by the gateway device according to an embodiment of the present disclosure.

FIG. 7 is a diagram showing an example of processing for comparing reference information with pattern information, which is performed by the gateway device according to an embodiment of the present disclosure.

FIG. 8 is a flowchart of an example of an operation procedure when the gateway device according to an embodiment of the present disclosure detects an abnormality in the in-vehicle network.

### DETAILED DESCRIPTION OF PREFERRED EMBODIMENTS

First, contents of embodiments of the present disclosure will be listed and described.

A monitoring device according to an embodiment of the present disclosure is configured to be installed in a vehicle and includes: a monitoring unit configured to monitor vehicle-related information regarding the vehicle transmitted in an in-vehicle network in the vehicle; a pattern information generating unit configured to generate pattern information that indicates changes in a plurality of types of the vehicle-related information, based on a result of monitoring performed by the monitoring unit; an abnormality detection unit configured to compare the pattern information generated by the pattern information generating unit with reference information that is pattern information used for reference, and detect an abnormality in the in-vehicle network based on a result of comparison; and a transmission unit configured to transmit the pattern information and the reference information to an external device outside the vehicle when the abnormality is detected by the abnormality detection unit.

With this configuration in which an abnormality is detected with use of data indicating changes in a plurality of types of vehicle-related information, it is possible to grasp the state of the vehicle in more detail, detect smaller changes in the vehicle, and improve detection accuracy, compared with a configuration in which a specific type of information at a specific timing is used for detection of an abnormality, for example. Also, with this configuration in which the pattern information and the reference information compared with each other are transmitted to the external device, the abnormality can be analyzed by the external device that can grasp a wider range of information, and accordingly, it is possible to perform more advanced analysis on the state of the vehicle and take appropriate measures. For example, it is possible to prevent a situation in which the user does not notice unauthorized access to the vehicle or data tampering in the vehicle and continues to use the vehicle without noticing some problems in the vehicle. Also, even vehicles of the same model do not necessarily have the same communication pattern of vehicle-related information in the vehicles, and there are various patterns according to habits of users, but with the configuration in which the pattern information and the reference information compared with each other are transmitted to the external device, it is possible to perform analysis more accurately for each user. Therefore, it is possible to grasp the state of the vehicle more accurately and make appropriate determination on abnormalities in the vehicle.

The monitoring device may further include a travel state determination unit configured to determine a travel state of the vehicle based on the result of monitoring performed by the monitoring unit, and the abnormality detection unit may select the reference information corresponding to the travel state and compare the selected reference information with the pattern information.

With this configuration, the comparison can be made according to the travel state of the vehicle, and therefore, an abnormality can be detected more accurately.

The monitoring device may further include a reference information obtaining unit configured to obtain and store the reference information that is based on the result of monitoring performed by the monitoring unit.

With this configuration, it is possible to use vehicle-related information actually transmitted in the same vehicle, and therefore, it is possible to use more appropriate reference information for detection of an abnormality.

The monitoring device may further include a travel state determination unit configured to determine a travel state of the vehicle based on the result of monitoring performed by the monitoring unit, and the reference information obtaining unit may obtain and store the reference information for each travel state.

With this configuration, the comparison can be made with use of reference information corresponding to the travel state of the vehicle and generated with use of vehicle-related information actually transmitted in the same vehicle, and therefore, an abnormality can be detected more accurately.

The reference information obtaining unit may update the reference information to the pattern information newly generated by the pattern information generating unit, based on the result of comparison between the newly generated pattern information and the reference information.

With this configuration, it is possible to use appropriate reference information according to a change of the driver or owner of the vehicle after the shipment of the vehicle, and it is possible to detect an abnormality more accurately.

The reference information obtaining unit may update the reference information to the pattern information newly generated by the pattern information generating unit, based on a history of operations made to the vehicle.

With this configuration, it is possible to update reference information periodically or non-periodically, and accordingly, it is possible to use appropriate reference information according to a change made after the shipment of the vehicle, and it is possible to detect an abnormality more accurately.

The pattern information may include data indicating a change in the vehicle-related information relating to an operation made to the vehicle.

With this configuration, it is possible to detect an abnormality by using information with which behaviors of the vehicle can be grasped more accurately, and therefore, it is possible to detect an abnormality more accurately.

The abnormality detection unit may compare changes in the vehicle-related information indicated by the pattern information with changes in the vehicle-related information indicated by the reference information, and when a condition that the number of times it is determined that the pattern information does not match with the reference information is larger than or equal to a predetermined threshold is satisfied, the abnormality detection unit may determine that an abnormality has occurred.

With this configuration, an abnormality can be detected through simple processing with use of data indicating changes in the vehicle-related information, and therefore, a processing load can be reduced.

The monitoring device may further include a travel state determination unit configured to determine a travel state of the vehicle based on the result of monitoring performed by the monitoring unit, and, when the condition is satisfied in a plurality of the travel states, the abnormality detection unit may determine that an abnormality has occurred.

With this configuration in which it is determined that an abnormality has occurred when the pattern information does not match with the reference information in a plurality of travel states, it is possible to prevent a situation in which an abnormality is detected by mistake based on only a single travel state.

A vehicle monitoring system according to an embodiment of the present disclosure includes: a monitoring device configured to be installed in a vehicle; and an external device outside the vehicle, wherein the monitoring device includes: a monitoring unit configured to monitor vehicle-related information regarding the vehicle transmitted in an in-vehicle network in the vehicle; a pattern information generating unit configured to generate pattern information that indicates changes in a plurality of types of the vehicle-related information, based on a result of monitoring performed by the monitoring unit; an abnormality detection unit configured to compare the pattern information generated by the pattern information generating unit with reference information that is pattern information used for reference, and detect an abnormality in the in-vehicle network based on a result of comparison; and a transmission unit configured to transmit the pattern information and the reference information to the external device outside the vehicle when the abnormality is detected by the abnormality detection unit, and the external device analyzes the pattern information and the reference information received from the monitoring device.

With this configuration in which an abnormality is detected with use of data indicating changes in a plurality of types of vehicle-related information, it is possible to grasp the state of the vehicle in more detail, detect smaller changes in the vehicle, and improve detection accuracy, compared with a configuration in which a specific type of information at a specific timing is used for detection of an abnormality, for example. Also, with this configuration in which the pattern information and the reference information compared with each other are transmitted to the external device, the abnormality can be analyzed by the external device that can grasp a wider range of information, and accordingly, it is possible to perform more advanced analysis on the state of the vehicle and take appropriate measures. For example, it is possible to prevent a situation in which the user does not notice unauthorized access to the vehicle or data tampering in the vehicle and continues to use the vehicle without noticing some problems in the vehicle. Also, even vehicles of the same model do not necessarily have the same communication pattern of vehicle-related information in the vehicles, and there are various patterns according to habits of users, but with the configuration in which the pattern information and the reference information compared with each other are transmitted to the external device, it is possible to perform analysis more accurately for each user. Therefore, it is possible to grasp the state of the vehicle more accurately and make appropriate determination on abnormalities in the vehicle.

A vehicle monitoring method according to an embodiment of the present disclosure is performed by a monitoring device installed in a vehicle and includes: monitoring vehicle-related information regarding the vehicle transmitted in an in-vehicle network in the vehicle; generating pattern information that indicates changes in a plurality of types of the vehicle-related information, based on a result of monitoring; comparing the generated pattern information with reference information that is pattern information used for reference, and detecting an abnormality in the in-vehicle network based on a result of comparison; and transmitting the pattern information and the reference information to an external device outside the vehicle when the abnormality is detected.

With this configuration in which an abnormality is detected with use of data indicating changes in a plurality of types of vehicle-related information, it is possible to grasp the state of the vehicle in more detail, detect smaller changes in the vehicle, and improve detection accuracy, compared with a configuration in which a specific type of information at a specific timing is used for detection of an abnormality, for example. Also, with this configuration in which the pattern information and the reference information compared with each other are transmitted to the external device, the abnormality can be analyzed by the external device that can grasp a wider range of information, and accordingly, it is possible to perform more advanced analysis on the state of the vehicle and take appropriate measures. For example, it is possible to prevent a situation in which the user does not notice unauthorized access to the vehicle or data tampering in the vehicle and continues to use the vehicle without noticing some problems in the vehicle. Also, even vehicles of the same model do not necessarily have the same communication pattern of vehicle-related information in the vehicles, and there are various patterns according to habits of users, but with the configuration in which the pattern information and the reference information compared with each other are transmitted to the external device, it is possible to perform analysis more accurately for each user. Therefore, it is possible to grasp the state of the vehicle more accurately and make appropriate determination on abnormalities in the vehicle.

The following describes embodiments of the present disclosure with reference to the drawings. The same or equivalent elements are denoted by the same reference numerals in the drawings, and redundant descriptions of those elements are omitted. At least portions of the following embodiments may be combined as appropriate.

### Configuration and Operations

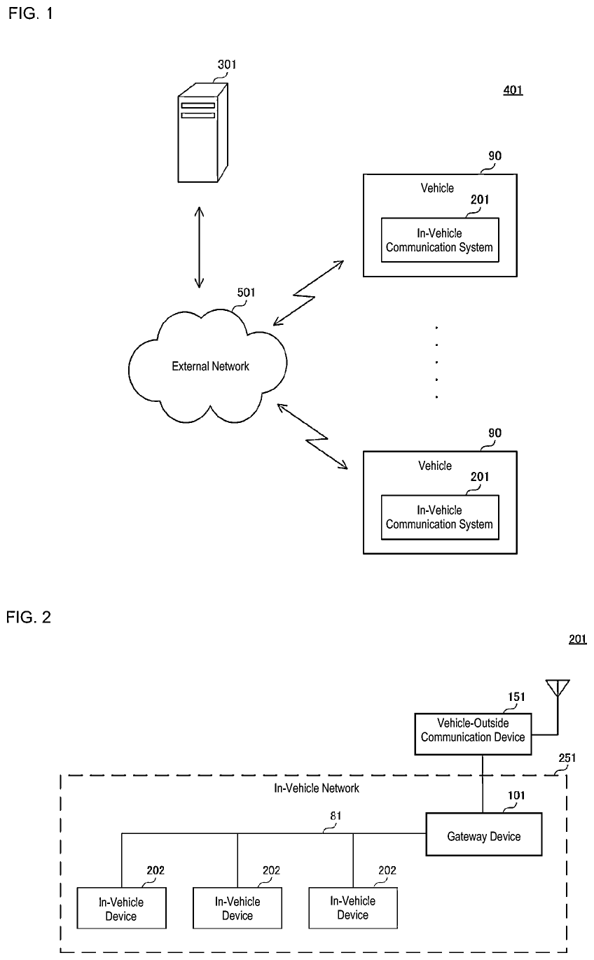

FIG. 1 is a diagram showing a configuration of a vehicle monitoring system according to an embodiment of the present disclosure. As shown in FIG. 1, a vehicle monitoring system 401 includes one or more in-vehicle communication systems 201 and a management server 301, which is an example of an external device. Each in-vehicle communication system 201 is installed in a vehicle 90.

Each in-vehicle communication system 201 obtains vehicle-related information regarding the vehicle 90 and detects an abnormality in an in-vehicle network in the vehicle 90 based on the vehicle-related information. Upon detecting an abnormality, the in-vehicle communication system 201 transmits information generated based on the vehicle-related information to the management server 301 via an external network 501.

The management server 301 receives the information transmitted from the in-vehicle communication system 201, analyzes the information, and performs processing for notifying a user of the fact that there was unauthorized access to the vehicle 90 or data tampering in the vehicle 90, for example, based on the analysis result.

FIG. 2 is a diagram showing a configuration of the in-vehicle communication system according to an embodiment of the present disclosure. As shown in FIG. 2, the in-vehicle communication system 201 includes a gateway device 101, which is an example of a monitoring device, one or more in-vehicle devices 202, and a vehicle-outside communication device 151. For example, an in-vehicle network 251 includes the gateway device 101 and the one or more in-vehicle devices 202. FIG. 2 shows an example in which the in-vehicle network 251 includes a single gateway device 101 and three in-vehicle devices 202.

The gateway device 101 is connected to the in-vehicle devices via a bus 81, for example. Specifically, the bus 81 conforms to standards such as CAN (Controller Area Network) (registered trademark), FlexRay (registered trademark), MOST (Media Oriented Systems Transport) (registered trademark), Ethernet (registered trademark), or LIN (Local Interconnect Network).

Examples of the in-vehicle devices 202 include a sensor, an actuator, a camera, a GPS (Global Positioning System) receiver, a navigation device, an autonomous driving processing ECU (Electronic Control Unit), ADAS (Advanced Driving Assistant System) ECU, a wiper control device, an engine control device, an AT (Automatic Transmission) control device, an HEV (Hybrid Electric Vehicle) control device, a brake control device, a chassis control device, a steering control device, a meter display control device, and a maintenance device.

The gateway device 101 is connected to the plurality of in-vehicle devices 202 and the vehicle-outside communication device 151 and capable of communicating with each in-vehicle device 202 and the vehicle-outside communication device 151. Note that not only the gateway device 101 but also an integrated ECU that controls operations of the in-vehicle devices 202 may be provided as an example of the monitoring device in the in-vehicle network 251.

Each in-vehicle device 202 periodically or non-periodically stores vehicle-related information indicating a measurement result or the like regarding the vehicle 90 and an ID of the in-vehicle device 202 in a frame and transmits the frame to the other in-vehicle devices 202 connected to the bus 81, for example. Note that a configuration is also possible in which each in-vehicle device 202 transmits the frame to the gateway device 101 or transmits the frame to another in-vehicle device (not shown) via the gateway device 101 and a cable or a bus (not shown). Also, a configuration is also possible in which each in-vehicle device 202 stores a plurality of types of vehicle-related information in a single frame and transmits the frame.

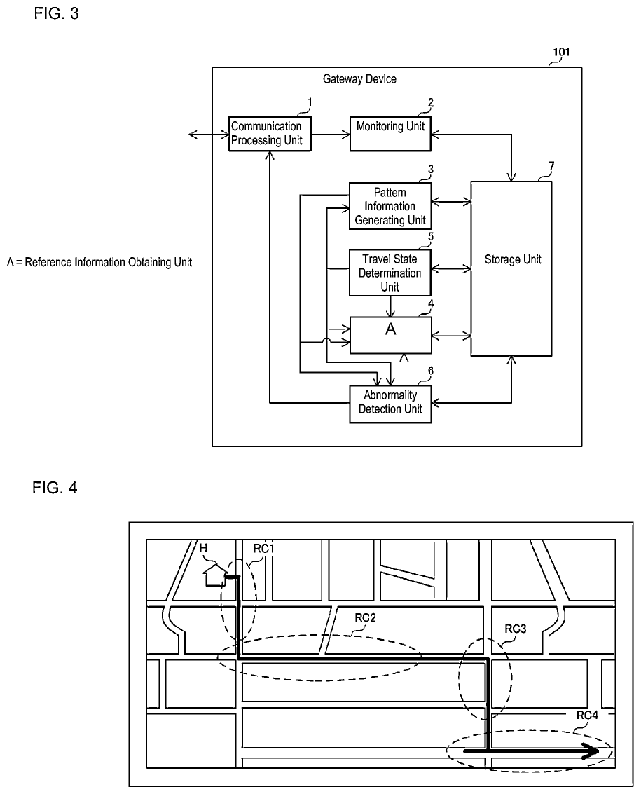

FIG. 3 is a diagram showing a configuration of the gateway device included in the in-vehicle communication system according to an embodiment of the present disclosure. As shown in FIG. 3, the gateway device 101 includes a communication processing unit 1, which is an example of a transmission unit, a monitoring unit 2, a pattern information generating unit 3, a reference information obtaining unit 4, a travel state determination unit 5, an abnormality detection unit 6, and a storage unit 7. The communication processing unit 1, the monitoring unit 2, the pattern information generating unit 3, the reference information obtaining unit 4, the travel state determination unit 5, and the abnormality detection unit 6 are realized by processors such as a CPU (Central Processing Unit) and a DSP (Digital Signal Processor), for example. The storage unit 7 is a non-volatile memory, for example.

In the case where frames are directly transmitted between the in-vehicle devices 202 via the bus 81, frames transmitted from each in-vehicle device 202 to the other in-vehicle devices 202 via the bus 81 are received in parallel by the communication processing unit 1. Note that the communication processing unit 1 may also be configured to receive a frame transmitted between in-vehicle devices, e.g., between an in-vehicle device 202 and the vehicle-outside communication device 151, to perform relay processing for relaying the frame.

Upon receiving a frame from an in-vehicle device 202 via the bus 81, the communication processing unit 1 adds a time stamp indicating the reception time of the frame to the received frame, and outputs the frame to the monitoring unit 2, for example.

The monitoring unit 2 monitors vehicle-related information regarding the vehicle 90 transmitted in the in-vehicle network 251 in the vehicle 90.

More specifically, the monitoring unit 2 obtains vehicle-related information and an ID stored in a frame received from the communication processing unit 1 and stores the vehicle-related information in association with the time stamp with respect to each ID in the storage unit 7. Thus, communication logs of the vehicle-related information in the in-vehicle network 251 are collected and stored in the storage unit 7.

The travel state determination unit 5 determines a travel state of the vehicle 90 based on the result of monitoring performed by the monitoring unit 2. More specifically, the travel state determination unit 5 refers to the communication logs stored in the storage unit 7, determines whether or not the travel state of the vehicle 90 corresponds to any of a plurality of specific travel states, for example, based on values (hereinafter also referred to as “signal values”) of the vehicle-related information (hereinafter also referred to as “signals”), and if the travel state corresponds to any of the specific travel states, outputs travel state information indicating the corresponding specific travel state to the pattern information generating unit 3 and the reference information obtaining unit 4.

The specific travel states are, for example, two or more of engine start, parking cancellation, right or left turn, stopping, starting, lane shifting, merging, and diverging.

FIG. 4 is a diagram showing an example of travel states of the vehicle determined by the gateway device according to an embodiment of the present disclosure.

As shown in FIG. 4, when the vehicle 90 started from a house H of the user and traveled along the route shown in FIG. 4, for example, the travel state determination unit 5 determines that the travel state of the vehicle 90 transitioned from a travel state RC1 to travel states RC2 to RC4 in this order based on the communication logs.

Referring back to FIG. 3, the pattern information generating unit 3 generates pattern information that is data indicating changes in a plurality of types of vehicle-related information, e.g., time series data of the plurality of types of vehicle-related information, based on the result of monitoring performed by the monitoring unit 2.

More specifically, when a predetermined condition for generating the pattern information is satisfied, e.g., upon receiving travel state information from the travel state determination unit 5, the pattern information generating unit 3 generates pattern information and outputs the pattern information to the reference information obtaining unit 4 and the abnormality detection unit 6.

For example, the pattern information includes data indicating a change in the vehicle-related information, e.g., time series data of the vehicle-related information, relating to an operation made to the vehicle 90.

Specifically, the vehicle-related information indicates states of an accelerator, a brake, a shift lever, a steering wheel, a power window, a blinker, an audio device, a wiper, a door, a hood, an ignition switch, etc. Also, the vehicle-related information indicates a vehicle speed, an acceleration rate, and a rotational speed of a tire, for example.

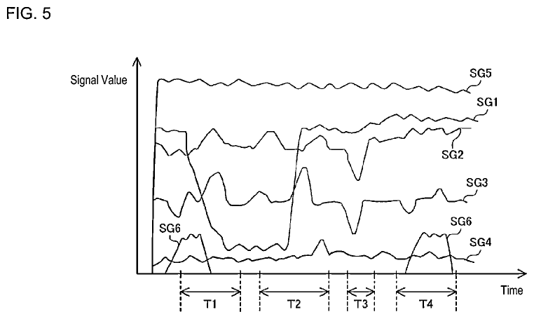

FIG. 5 is a diagram showing an example of time series data of signal values obtained in the in-vehicle communication system according to an embodiment of the present disclosure. In FIG. 5, the horizontal axis indicates time, and the vertical axis indicates signal values.

As shown in FIG. 5, the pattern information generating unit 3 generates pattern information indicating time series changes in a plurality of signals SG1 to SG6 for each of periods T1 to T4 corresponding to the travel states RC1 to RC4 shown in FIG. 4, respectively.

Note that, when the vehicle 90 turned to the left from the house H and traveled toward the upper side of the sheet of FIG. 4, the travel state determination unit 5 determines that the travel state of the vehicle 90 does not correspond to the specific travel states. In this case, the pattern information generating unit 3 does not generate pattern information.

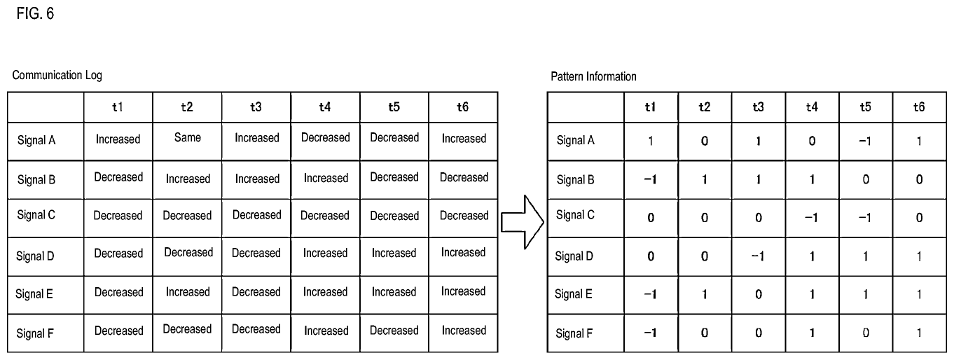

FIG. 6 is a diagram showing an example of pattern information generated by the gateway device according to an embodiment of the present disclosure.

As shown in FIG. 6, the pattern information generating unit 3 refers to the communication logs stored in the storage unit 7 and generates pattern information including values that are set according to whether a signal value at a time point increased or decreased from a signal value at a previous time point, for each of signals A to F in a period between time points t1 and t6, which corresponds to a specific travel state. In the example shown in FIG. 6, “1” is set when a signal value increased, “0” is set when a signal value is the same as the previous signal value, and “−1” is set when a signal value decreased.

The pattern information generating unit 3 generates such pattern information for each type of travel state. The number and types of signals included in the pattern information may differ between travel states or may be the same between some or all of the travel states.

Note that the pattern information generating unit 3 may be configured to generate pattern information like that described above by using a learning model according to a method of deep learning, which is an example of machine learning.

Referring back to FIG. 3, the abnormality detection unit 6 selects reference information corresponding to the travel state of the vehicle 90, for example, and compares the selected reference information with the pattern information.

More specifically, the abnormality detection unit 6 obtains, from the storage unit 7, reference information corresponding to the travel state indicated by the travel state information received from the travel state determination unit 5 and compares the obtained reference information with the pattern information received from the pattern information generating unit 3.

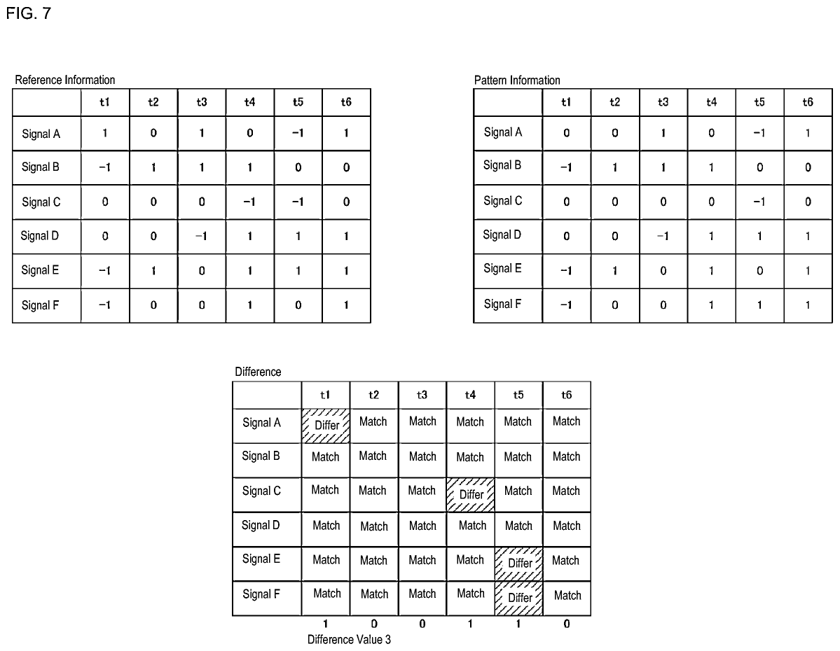

FIG. 7 is a diagram showing an example of processing for comparing reference information and pattern information, which is performed by the gateway device according to an embodiment of the present disclosure.

As shown in FIG. 7, the abnormality detection unit 6 compares each element of the reference information with a corresponding element of the newly generated pattern information and counts the number of time points at which those elements do not match.

In this example, there are differences between the reference information and the pattern information in the signal A at the time point t1, the signal C at the time point t4, and the signals E and F at the time point t5, and therefore, the abnormality detection unit 6 calculates a difference value to be 3.

When the difference value is larger than or equal to a predetermined threshold, the abnormality detection unit 6 determines that the pattern information “differs” from the reference information, and when the difference value is smaller than the predetermined threshold, the abnormality detection unit 6 determines that the pattern information “matches” with the reference information. Upon determining that the pattern information “matches” with the reference information, the abnormality detection unit 6 notifies the reference information obtaining unit 4 of the determination result.

The reference information obtaining unit 4 obtains and stores reference information that is based on the result of monitoring performed by the monitoring unit 2, for example. More specifically, the reference information obtaining unit 4 obtains reference information for each travel state and stores the reference information in the storage unit 7 as reference information corresponding to the travel state indicated by the travel state information received from the travel state determination unit 5, for example.

For example, the reference information obtaining unit 4 updates reference information to pattern information newly generated by the pattern information generating unit 3, based on the result of comparison between the newly generated pattern information and the reference information.

More specifically, upon receiving a notification indicating that the newly generated pattern information “matches” with the reference information from the abnormality detection unit 6, the reference information obtaining unit 4 updates the reference information corresponding to the travel state and stored in the storage unit 7 to the pattern information received from the pattern information generating unit 3.

Note that the reference information obtaining unit 4 may also be configured to update the reference information to the pattern information newly generated by the pattern information generating unit 3, based on a history of operations made to the vehicle 90, irrespective of the result of comparison performed by the abnormality detection unit 6 described above.

Specifically, every time the number of times the engine of the vehicle 90 has been started reaches a predetermined value, for example, the reference information obtaining unit 4 updates reference information corresponding to the travel state and stored in the storage unit 7 to the newly generated pattern information.

The abnormality detection unit 6 compares the pattern information generated by the pattern information generating unit 3 with the reference information, which is pattern information used for reference, and detects an abnormality in the in-vehicle network 251 based on the result of comparison.

For example, the abnormality detection unit 6 compares changes in the vehicle-related information indicated by the pattern information with changes in the vehicle-related information indicated by the reference information, and if a comparison condition that the number of times it is determined that the pattern information does not match with the reference information is larger than or equal to a predetermined threshold is satisfied, the abnormality detection unit 6 determines that an abnormality has occurred. Specifically, the abnormality detection unit 6 compares changes over time in the vehicle-related information indicated by the pattern information with changes over time in the vehicle-related information indicated by the reference information as described with reference to FIG. 7, and if a comparison condition that the number of times it is determined that the time series data of the pattern information does not match with the time series data of the reference information is larger than or equal to a predetermined value is satisfied, the abnormality detection unit 6 determines that an abnormality has occurred.

Alternatively, when the comparison condition is satisfied in a plurality of travel states, the abnormality detection unit 6 determines that an abnormality has occurred. Specifically, when the abnormality detection unit 6 has consecutively determined that the pattern information “differs” from the reference information a predetermined number of times in a series of travel of the vehicle 90, the abnormality detection unit 6 determines that an abnormality has occurred.

Note that the abnormality detection unit 6 may also be configured to determine that an abnormality has occurred, in a case where the comparison condition described above is satisfied in travel states, some or all of which are not consecutive, in a certain period of time.

As described above, the gateway device 101 can detect an abnormality through simple processing by using subtraction and comparison, and therefore, a processing load can be reduced.

Referring back to FIG. 3, when an abnormality is detected by the abnormality detection unit 6, the communication processing unit 1 transmits the pattern information and the reference information to the management server 301 outside the vehicle 90.

More specifically, upon detecting an abnormality, the abnormality detection unit 6 outputs the pattern information and the reference information compared with each other to the communication processing unit 1. Note that the abnormality detection unit 6 may also be configured to output not only the compared reference information but also pieces of reference information corresponding to all travel states stored in the storage unit 7 to the communication processing unit 1. Alternatively, the abnormality detection unit 6 may also be configured to output all pattern information and reference information for which it was determined that the pattern information “differs” from the reference information, or output some of the information such as the latest pattern information and the reference information. Alternatively, the abnormality detection unit 6 may also be configured to periodically or non-periodically output information indicating that the in-vehicle network is in a normal state to the communication processing unit 1 when an abnormality has not been detected.

The communication processing unit 1 outputs the pattern information and one or more pieces of reference information received from the abnormality detection unit 6 to the vehicle-outside communication device 151.

The vehicle-outside communication device 151 performs wireless communication with a wireless base station (not shown) in accordance with a communication method such as WiFi (registered trademark) or LTE (Long Term Evolution) (registered trademark) to communicate with the management server 301 via the external network 501 shown in FIG. 1.

For example, the vehicle-outside communication device 151 receives the pattern information and the reference information from the communication processing unit 1 included in the gateway device 101 and transmits the pattern information and the reference information via the external network 501 to the management server 301.

The management server 301 receives the pattern information and the reference information, which are transmitted from the vehicle-outside communication device 151, via the external network 501 and analyzes the pattern information and the reference information. Then, the management server 301 transmits analysis information indicating the analysis result via the external network 501 to a user terminal (not shown) or the vehicle 90, for example.

### Flow of Operations

The monitoring device according to an embodiment of the present disclosure includes a computer that includes a memory, and a computation processing unit such as a CPU included in the computer reads a program including some or all steps in a flowchart and a sequence described below from the memory and executes the program. The program can be installed from the outside of the monitoring device. The program is stored in a recording medium and distributed or is distributed via a communication line.

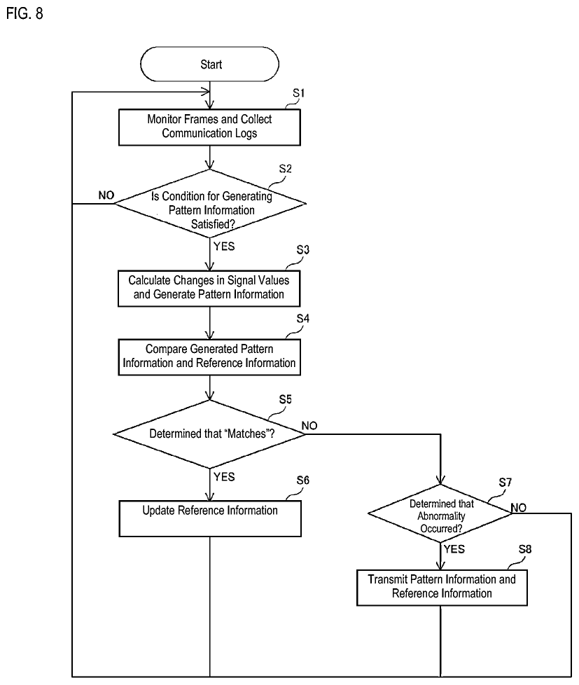

FIG. 8 is a flowchart of an example of an operation procedure when the gateway device according to an embodiment of the present disclosure detects an abnormality in the in-vehicle network.

As shown in FIG. 8, first, the gateway device 101 monitors frames transmitted from the in-vehicle devices 202 in the in-vehicle network 251 and collects communication logs of vehicle-related information (step S1).

Next, the gateway device 101 collects the communication logs until a condition for generating pattern information is satisfied, e.g., until the travel state of the vehicle 90 corresponds to a specific travel state (NO in step S2), and when the condition is satisfied (YES in step S2), generates pattern information by calculating changes in signals values as shown in FIG. 6, for example (step S3).

Next, the gateway device 101 compares the generated pattern information with reference information that has been stored, as shown in FIG. 7, for example (step S4), and upon determining that the pattern information “matches” with the reference information (YES in step S5), updates the reference information stored in the storage unit 7, e.g., reference information corresponding to the specific travel state described above to the currently generated pattern information. This makes it possible to use appropriate reference information according to a change of the driver or owner of the vehicle 90 (step S6).

On the other hand, when it is determined that the generated pattern information “differs” from the stored reference information (NO in step S5) and a predetermined condition is satisfied, e.g., it has been consecutively determined that pattern information “differs” from reference information a predetermined number of times, the gateway device 101 determines that an abnormality has occurred in the in-vehicle network 251 (YES in step S7).

Next, the gateway device 101 transmits the compared pattern information, reference information, etc., to the management server 301 (step S8).

On the other hand, when it is determined that the generated pattern information “differs” from the stored reference information (NO in step S5) and the determination that pattern information “differs” from reference information has not been made consecutively the predetermined number of times, the gateway device 101 determines that an abnormality has not occurred in the in-vehicle network 251 (NO in step S7). Then, the gateway device 101 continues monitoring frames and collecting communication logs (step S1).

Note that time series data of a plurality of types of vehicle-related information is described as an example of pattern information in the embodiments of the present disclosure, but the pattern information is not limited to this example. For example, pattern information may also be data indicating changes in signal values according to the position or speed of the vehicle 90. In this case, the pattern information is data in which the time points t1 to t6 shown in FIG. 6 are replaced with positions or speeds of the vehicle 90, for example. That is to say, it is sufficient that pattern information is data indicating changes in a plurality of types of vehicle-related information.

The above embodiments are illustrative examples in all aspects and should not be considered as restrictive. The scope of the present disclosure is defined not by the above descriptions but by the claims, and is intended to encompass all modifications within the meanings and scope that are equivalent to the claims.

1. A monitoring device configured to be installed in a vehicle, the monitoring device comprising:
a monitoring unit configured to monitor vehicle-related information regarding the vehicle transmitted in an in-vehicle network in the vehicle;
a pattern information generating unit configured to generate pattern information that indicates changes in a plurality of types of the vehicle-related information, based on a result of monitoring performed by the monitoring unit;
an abnormality detection unit configured to compare, type by type, the pattern information generated by the pattern information generating unit with reference information that is pattern information used for reference, and detect an abnormality in the in-vehicle network based on a result of comparison; and
a transmission unit configured to transmit the pattern information and the reference information to an external device outside the vehicle when the abnormality is detected by the abnormality detection unit.

2. The monitoring device according to claim 1, further comprising:
a travel state determination unit configured to determine a travel state corresponding to a travel state of the vehicle among a plurality of travel states based on the result of monitoring performed by the monitoring unit,
wherein the abnormality detection unit selects the reference information corresponding to the travel state determined as the corresponding travel state by the travel state determination unit and compares the selected reference information with the pattern information.

3. The monitoring device according to claim 1, further comprising:
a reference information obtaining unit configured to obtain and store the reference information that is based on the result of monitoring performed by the monitoring unit.

4. The monitoring device according to claim 3, further comprising:
a travel state determination unit configured to determine a travel state corresponding to a travel state of the vehicle among a plurality of travel states based on the result of monitoring performed by the monitoring unit,
wherein the reference information obtaining unit stores the reference information based on the result of monitoring as the reference information corresponding to the travel state determined as the corresponding travel state by the travel state determination unit.

5. The monitoring device according to claim 3, wherein the reference information obtaining unit updates the reference information to the pattern information newly generated by the pattern information generating unit, based on the result of comparison between the newly generated pattern information and the reference information.

6. The monitoring device according to claim 3, wherein the reference information obtaining unit updates the reference information to the pattern information newly generated by the pattern information generating unit, based on a history of operations made to the vehicle.

7. The monitoring device according to claim 1, wherein the pattern information includes data indicating a change in the vehicle-related information relating to an operation made to the vehicle.

8. The monitoring device according to claim 1, wherein the abnormality detection unit compares changes in the vehicle-related information indicated by the pattern information with changes in the vehicle-related information indicated by the reference information, and when a condition that the number of times it is determined that the pattern information does not match with the reference information is larger than or equal to a predetermined threshold is satisfied, the abnormality detection unit determines that an abnormality has occurred.

9. The monitoring device according to claim 8, further comprising:
a travel state determination unit configured to determine a travel state of the vehicle based on the result of monitoring performed by the monitoring unit,
wherein, when the condition is satisfied in a plurality of the travel states, the abnormality detection unit determines that an abnormality has occurred.

10. A vehicle monitoring system comprising:
a monitoring device configured to be installed in a vehicle; and
an external device outside the vehicle,
wherein the monitoring device includes:
a monitoring unit configured to monitor vehicle-related information regarding the vehicle transmitted in an in-vehicle network in the vehicle;
a pattern information generating unit configured to generate pattern information that indicates changes in a plurality of types of the vehicle-related information, based on a result of monitoring performed by the monitoring unit;
an abnormality detection unit configured to compare, type by type, the pattern information generated by the pattern information generating unit with reference information that is pattern information used for reference, and detect an abnormality in the in-vehicle network based on a result of comparison; and
a transmission unit configured to transmit the pattern information and the reference information to the external device outside the vehicle when the abnormality is detected by the abnormality detection unit,
wherein the external device analyzes the pattern information and the reference information received from the monitoring device.

11. A vehicle monitoring method performed by a monitoring device installed in a vehicle, the vehicle monitoring method comprising:
monitoring vehicle-related information regarding the vehicle transmitted in an in-vehicle network in the vehicle;
generating pattern information that indicates changes in a plurality of types of the vehicle-related information, based on a result of monitoring;
comparing, type by type the generated pattern information with reference information that is pattern information used for reference, and detecting an abnormality in the in-vehicle network based on a result of comparison; and
transmitting the pattern information and the reference information to an external device outside the vehicle when the abnormality is detected.
